(19) United States
(12) Patent Application Publication
(10) Pub. No.: US 2006/0080517 A1
(43) Pub. Date: Apr. 13, 2006

(54) Accessing a protected area of a storage device

(76) Inventor: Christopher Lynn Tycho Brown, Coronado, CA (US)

Correspondence Address: FISH & RICHARDSON, PC, P.O. BOX 1022, MINNEAPOLIS, MN, 55440-1022, US

(21) Appl. No.: 10/713,853

(22) Filed: Nov. 14, 2003

(51) Int. Cl. G06F 12/14

(52) U.S. Cl. 711/163

(57) ABSTRACT

Systems and techniques to access a protected area of a storage device. In general, in one implementation, the technique includes: determining whether a storage device, in a data processing system running an operating system, includes a protected area, the operating system including a hardware abstraction layer; removing the storage area protection of the storage device from within the running operating system and without rebooting the data processing system; and providing information derived from the formerly protected storage area to a data processing system detection tool. Removing the storage area protection can involve volatilely resetting a storage address value. Providing the information derived from the formerly protected storage area can involve sending the information over a selected transport medium to the detection tool using a common packet structure that supports multiple transports. Moreover, a file system of the formerly protected storage area can be reconstructed.

### BACKGROUND

The present application describes systems and techniques relating to accessing a protected area of a storage device.

Modern computers frequently include hard disks with hardware protected areas. A hardware protected area is an area of a hard disk intended to be inaccessible to users through a higher level operating system. Traditional computer forensics tools that image or analyze the hardware protected area of a disk typically use Disk Operating System (DOS) based utilities, which have access to interrupt calls made directly to hardware. Traditional hardware protected area design specifications only describe use and access to the hardware protected area from within a DOS based application or the systems BIOS (Basic Input Output System).

Typically, DOS based utilities for removing the hardware protected area use a DOS boot floppy disk created for the computer and containing the utility. The newly created DOS boot disk is used to hard boot or reboot the system containing the hardware protected area disk. The hardware protected area is typically removed permanently by computer forensics tools, and the disk containing the hardware protected area is frequently altered in this process. Once the hardware protected area is removed permanently, the data contained in the once hardware protected area generally resides in unallocated disk space, and manual reassembly of any file data is then performed.

### SUMMARY

The present disclosure includes systems and techniques relating to accessing a protected area of a storage device. According to an aspect, an article includes a machine-readable medium embodying information indicative of instructions that when performed by one or more machines result in the following operations: determining whether a storage device, in a data processing system running an operating system, includes a protected area, the operating system including a hardware abstraction layer; removing the storage area protection of the storage device from within the running operating system and without rebooting the data processing system; and providing information derived from the formerly protected storage area to a data processing system detection tool.

Removing the storage area protection can involve volatilely resetting a storage address value. Providing the information derived from the formerly protected storage area can involve sending the information over a transport medium to the detection tool (e.g., a computer forensics tool). The transport medium can be selected from a group including a peripheral device interface medium and a network communications medium, and a common packet structure can be used for multiple transports. Moreover, a file system of the formerly protected storage area can be reconstructed, either by the detection tool or by a detection agent that communicates protected area information to a remote detection tool.

One or more of the following advantages may be provided by the systems and techniques described. A hardware protected storage area can be identified and accessed, without altering the storage device and without needing to reboot, from within a high level operating system (e.g., from within a Windows based application). The formerly protected storage area can be scanned for a file system, and any files found can be viewed and copied from within the high level operating system. The access to and scanning of the protected storage area can be done in a networked environment; imaging and analysis of the protected storage area can be done over a TCP/IP (Transmission Control Protocol/Internet Protocol) network. Moreover, the packet structure used can facilitate communications over multiple transports, and an appropriate communications medium can be selected based on current conditions when the protected storage area is accessed. All of this can be done together without altering the storage medium.

Details of one or more implementations are set forth in the accompanying drawings and the description below. Other features and advantages may be apparent from the description and drawings, and from the claims.

### BRIEF DESCRIPTION OF THE DRAWINGS

FIG. 1 is a block diagram illustrating an example data processing system.

FIG. 2 is a block diagram illustrating components of a data processing system, including components used to access a protected area of a storage device.

FIG. 3 is a flowchart illustrating provision of access to a protected area of a storage device.

FIG. 4 is a block diagram illustrating a protected storage area accessing system.

FIG. 5 is a block diagram illustrating a protected storage area accessing system.

FIGS. 6-24 illustrate an example packet structure that can be used efficiently over multiple transports.

FIGS. 25-26 illustrate user interfaces for an example client-server computer forensics product.

### DETAILED DESCRIPTION

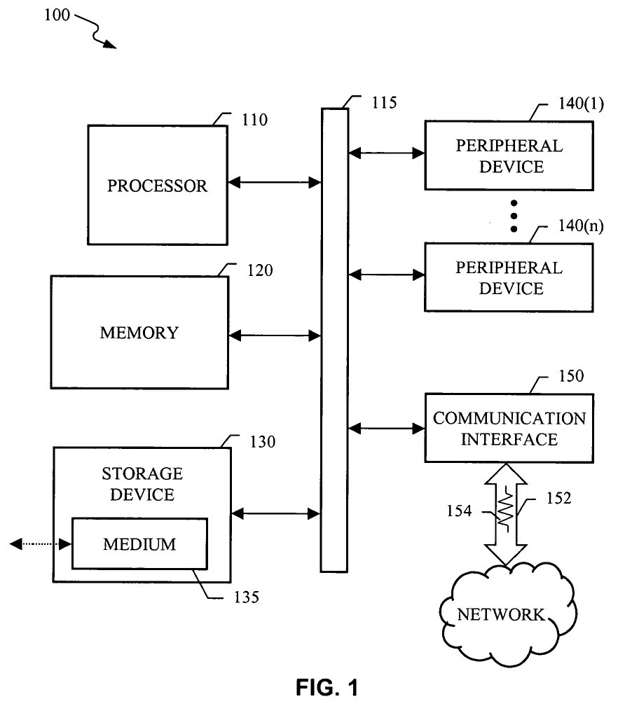

FIG. 1 is a block diagram illustrating an example data processing system 100. The data processing system 100 includes a processor 110, which executes programs, performs data manipulations and controls tasks in the system 100. The processor 110 is coupled with a bus 115 that can include multiple busses, which can be parallel and/or serial busses.

The data processing system 100 includes a memory 120, which can be volatile and/or non-volatile memory, and is coupled with the communications bus 115. The system 100 can also include one or more cache memories. The data processing system 100 can include a storage device 130 for accessing a medium 135, which may be removable, read-only or read/write media and may be magnetic, optical, holographic, semiconductor-based media, or a combination of these. The data processing system 100 can also include one or more peripheral devices 140(l)-140(n) (collectively, devices 140, e.g., connected using a Universal Serial Bus (USB)), and one or more controllers and/or adapters for providing interface functions. The peripheral devices 140 can also include one or more storage devices, such as the storage device 130.

The system 100 can further include a communication interface 150, which allows software and data to be transferred, in the form of signals 154 over a channel 152, between the system 100 and external devices, networks or information sources. The signals 154 can embody instructions for causing the system 100 to perform operations. The system 100 represents a programmable machine, and can include various devices such as embedded controllers, Programmable Logic Devices (PLDs), Application Specific Integrated Circuits (ASICs), and the like. Example machines represented by the system 100 include a personal computer, a mobile computing system, a workstation, a minicomputer, a server, a mainframe, a supercomputer, etc. Machine instructions (also known as programs, software, software applications or code) can be stored in the machine 100 and/or delivered to the machine 100 over a communication interface. These instructions, when executed, enable the machine 100 to perform the features and function described here. These instructions represent controllers of the machine 100 and can be implemented in a high-level procedural and/or object-oriented programming language, and/or in assembly/machine language. Such languages can be compiled and/or interpreted languages.

As used herein, the term “machine-readable medium” refers to any software product, computer program product, apparatus and/or device used to provide machine instructions and/or data to the machine 100, including a machine-readable medium that receives machine instructions as a machine-readable signal. Examples of a machine-readable medium include the medium 135 and the memory 120. The term “machine-readable signal” refers to any signal, such as the signals 154, used to provide machine instructions and/or data to the machine 100. The term “storage device” refers to any apparatus having a machine-readable medium suitable for prolonged storage of data and/or code.

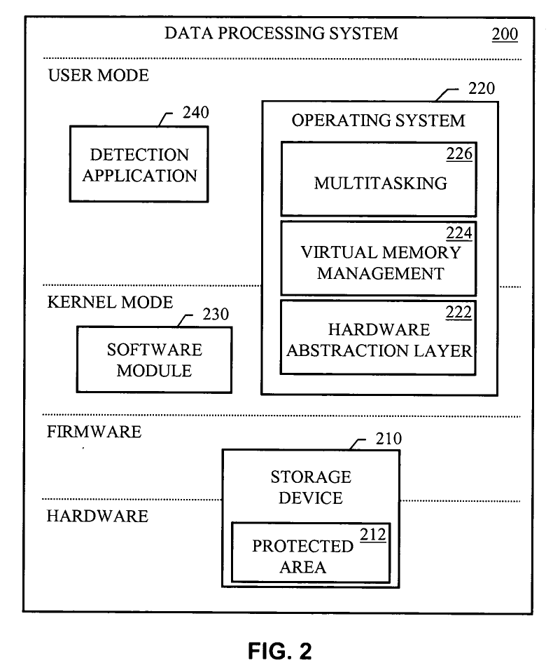

FIG. 2 is a block diagram illustrating components of a data processing system 200, including components used to access a protected area 212 of a storage device 210. The data processing system 200 can be generally divided into four layers: hardware, firmware, kernel mode, and user mode. A high level operating system (OS) 220 generally prohibits user-mode applications from directly accessing hardware, such as the storage device 210. Examples of high level operating systems include the family of Windows™ operating systems provided by Microsoft Corporation of Redmond, Wash., UNIX™ operating systems provided by many vendors under license from The Open Group, and Linux™ operating systems, which are based on a freely-distributable open source Linux™ operating system. The OS 220 can include a kernel that handles memory management, process and task management, and disk management. The OS 220 can include a hardware abstraction layer 222, virtual memory management 224, and multitasking 226. The hardware abstraction layer 222 represents any OS component that implements a protected mode of operation that restricts direct access to storage hardware.

The storage device 210 includes a protected area 212. The protected storage area 212 is an area of the machine-readable medium in the device 210 that is intended to be accessible only during system boot time and is otherwise hidden from the operating system 220. For example, the American National Standards Institute has defined the Hardware Protected Area (HPA) in ATA/ATAPI-4 (NCITS 317-1998). Additionally, the Protected Area Run Time Interface Extension Services (PARTIES) or ANSI NCITS 346-2001 specifies a BIOS (Basic Input Output System) interface for addressing the hardware protected area. The HPA offers system manufacturers a place to store information and utilities in a hidden area of an ATA (Advanced Technology Attachment) hard disk that is generally not accessible by an every day user of a computing system.

The protected area 212 of the storage device 210 effectively offers malicious users a place to store contraband or malware. Since the protected area 212 is not normally seen by the system BIOS or operating system, many computer forensics tools do not detect, analyze or image this area, or at least cannot do so easily. To assist law enforcement and information security personnel in determining if a user has utilized the protected area 212 to hide contraband or malware, a kernel-mode software module 230 can be used to provide access to the protected area 212 and enable live imaging and analysis of the protected area 212 from within the running operating system 220 and without rebooting the data processing system 200.

The kernel-mode software module 230 can be a device driver (e.g., a Windows Driver Model (WDM) driver). The software module 230 can be loaded into memory by a detection application 240, and the software module 230 can provide a detection tool with access to the protected area 212. The detection application 240 can be the detection tool itself, or the detection application 240 can be a detection agent that sends information derived from the protected area 212 to a remote detection tool. The detection tool can be a software application designed for use in computer forensics, security, internal investigations, incident response, electronic discovery and/or intrusion detection. For example, the detection tool can be a remote security tool that uses the detection agent 240 to verify the integrity of the storage device 210.

Thus, the software module 230 and the detection application 240 can provide direct and live access to the protected storage area 212 in order to image or analyze the protected storage area 212 in support of some detection function. The software module 230 and the detection application 240 enable direct access to the protected storage area live from the high level operating system without the need to reboot. In effect, the kernel-mode software module 230 operates as a broker for the detection application 240, providing direct hardware access to the user-mode application despite the hardware abstraction layer 222. Moreover, the removal of the protected storage area 212 (i.e., the removal of the protection) can be done volatilely so the protection can be restored by the next system reboot, leaving the storage device 210 unaltered.

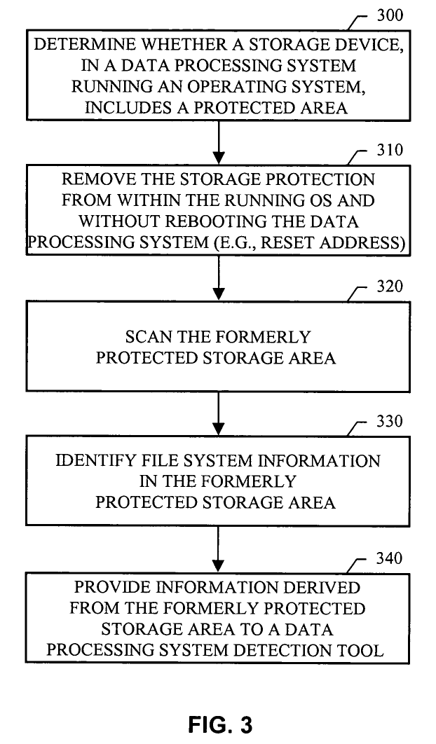

FIG. 3 is a flowchart illustrating provision of access to a protected area of a storage device. A determination is made as to whether a storage device, in a data processing system running an operating system, includes a protected area at 300. This can involve checking whether the storage device supports a protected area specification, and identifying a protected storage capacity and an unprotected storage capacity of the storage device. For example, a loaded protected-area-removal (PARemove) device driver can detect the number of IDE (Integrated Drive Electronics) hard disks connected to the system by sending disks command codes.

For each IDE hard disk, the PARemove driver can retrieve the hard disk make and size using hard disk command codes, and the PARemove driver can determine whether the hard disk is capable of handling ATA/ATAPI-5 command set. If the hard disk is not capable of handling ATA/ATAPI-5 command set, the PARemove driver can declare that the hard disk has no hardware protected area present. If the hard disk is capable of handling ATA/ATAPI-5 command set, the PARemove driver can request the maximum number of sectors (unprotected) from the disk using hard disk command codes to determine if the hard disks has a hardware protected area set.

If there is a protected area, the storage protection is removed from within the running OS and without rebooting the data processing system at 310. This can involve volatilely resetting a storage address value. For example, the PARemove driver can remove the protection using the Set MAX ADDRESS command, allowing user-mode application access to the entire disk. A switch in the Set MAX ADDRESS command can be set to perform the address change volitely, leaving the disk unmodified. Once a user-mode application using the PARemove device driver has shut down, the disk can be returned to its normal state with the hardware protected area in tact.

Once the storage protection is removed, the formerly protected storage area can be scanned at 320. File system information can be identified in the formerly protected storage area at 330. For example, sector reads can be performed on a hard disk, and the sectors can be analyzed to find and build the file system for display to a user. Reconstructing the file system of the formerly protected storage area can be done locally or remotely, as described further below, and can involve security checks (e.g., hashing to check for matches).

A hard disk with a formerly protected storage area can be accessed in LBA (Large Block Address) mode to retrieve the native max address capability. When obtaining the native max address, the data structure returned can provide the native max sectors in the following format:

Sector Number Reg (0×1f3): Native Max 0-7 bits

Cylinder Low Reg (0×1f4): Native Max 8-15

Cylinder high Reg (0×1f5): Native Max 16-23

Device/Head Reg (0×1f6): Native Max 24-27

The structures returned in different systems (e.g., boot extension engineering records) can vary, and the different structures can be investigated to determine how best to identify the native max address for each system to be accessed. In general, a storage device can be scanned sector by sector to look for one or more file descriptive records (e.g., a file allocation table (FAT) or a master file table (MFT)) and/or other structures associated with one or more possible file systems used in the formerly protected storage area. These structures and/or file descriptive records can then be used to rebuild the file system.

Information derived from the formerly protected storage area is provided to a data processing system detection tool at 340. The detection tool can be local or remote as mentioned above in connection with FIG. 2: the detection application 240 can be the detection tool itself, or the detection application 240 can be a detection agent that sends information derived from the protected area 212 to a remote detection tool. The information provided to a remote detection tool can come directly from the formerly protected storage area (e.g., sector reads of the hard disk), or the information can be processed locally first before being sent (e.g., the detection agent can include one or more file system interpreters that output the information).

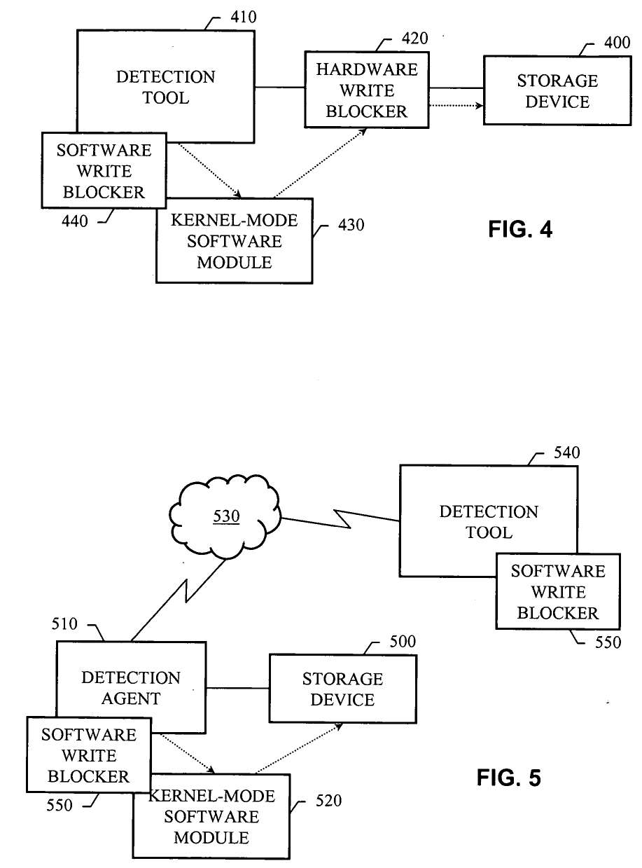

FIG. 4 is a block diagram illustrating a protected storage area accessing system. The system includes a storage device 400 and a detection tool 410. The detection tool 410 can load a kernel-mode software module 430, which can provide the detection tool 410 with full read access to a protected area of the storage device 400. The detection tool 410 and the storage device 400 can both be part of the same data processing system, and the detection tool 410 can access the storage device 400 over a bus (e.g., a system bus or a USB cable). The system can be a forensics workstation to which the storage device 400 is connected for imaging and analysis (e.g., a hard disk plugged into a tray of a forensics workstation).

The system can include a hardware write blocker 420 that prevents the storage device's machine-readable medium from being altered. The hardware write blocker 420 can be operable to allow the kernel-mode software module 430 to access one or more firmware commands that do not alter the machine-readable medium (e.g., the Set MAX ADDRESS command). The system can also include a software write blocker 440, which can be integrated with the detection tool 410 and/or the kernel-mode software module 430. The detection tool 410 can be operable as a stand alone application and as a client application, providing flexibility in how the application can be used.

FIG. 5 is a block diagram illustrating a protected storage area accessing system. A storage device 500 can be accessed by a detection agent 510 using a kernel-mode software module 520. The storage device 500 and the detection agent 510 can be part of the same data processing system. The detection agent 510 and the kernel-mode software module 520 can be temporary additions to the system that are only loaded into volatile memory and do not remain after a protected area of the storage device 500 has been accessed. For example, the detection agent 510 and the kernel-mode software module 520 can be tangibly embodied in a machine-readable medium that is coupled with a computing system (e.g., the agent 510 and the module 520 can be on an optical disk that is inserted into the system). When coupled with the system, the detection agent 510 can run and dynamically load the kernel-mode software module 520 in memory without altering the storage device 500. A software installation is not required.

The detection agent 510 can send information to a detection tool 540 over a network 530 (e.g., a local area and/or wide area network). The detection agent 510 can communicate with both the kernel-mode software module 520 and the detection tool 540, and the detection agent 510 can provide information derived from the protect storage area to the detection tool 540 for imaging and analysis. Moreover, the detection agent 510 can reconstruct a file system of the protected storage area and send the reconstructed file system information to the detection tool 540. The detection agent 510 can also include additional functionality that condenses and enhances the information provided to the detection tool 540. The detection agent 510 can confirm the integrity of the storage device 500, and the detection agent 510 can be operable with different types of detection tools in an enterprise environment with added security to handle multiple communication steams (e.g., the detection agent 510 can employ multi-factor authentication and digital certificates to increase security). The system can also include a software write blocker 550 that can be integrated with the detection tool 540, the detection agent 510, and/or the kernel-mode software module 520.

In general, the detection agent 510 and the detection tool 540 can be designed to communicate over a selected transport medium, where a group of multiple transports are supported. For example, the transport medium can be selected based on current conditions from a group including a peripheral device interface medium and a network communications medium. Sending the information over the selected transport medium can involve using packets having a packet structure useable over both the peripheral device interface medium and the network communications medium (e.g., packets useable over an IP network, over USB, and over a parallel port interface).

Thus, the detection agent 510 can act as a server application that, once run on a computing system, can dynamically load the kernel-mode software module 520 in the data processing system, detect a network connection, and set up a listening TCP/IP port allowing the detection tool 540, which acts as a client application running on another data processing system, to connect over any TCP/IP network and access the entire machine-readable medium of the storage device 500, including any formerly protected storage area.

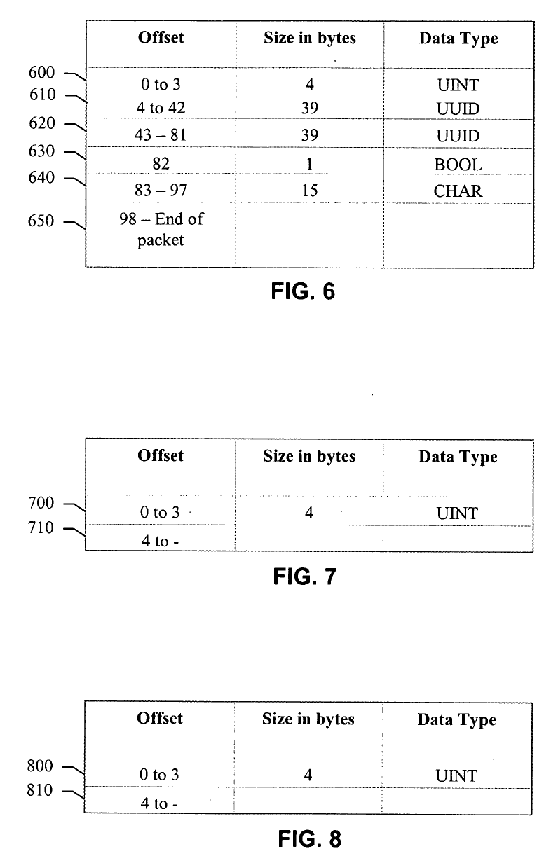

In the client-server mode of operation, a common packet structure can accommodate multiple transports, providing flexibility in access and potentially increasing the speed of storage device analysis. The common packet structure can include a packet identifier field used by the detection agent 510 and the detection tool 540 to serialize the data stream and provide added communications security. The packet structure can allow a strictly one-to-one connection to be specified to increase communications security (i.e., the server agent may be limited to communicating with only one client at a time). Small packets can be used to reduce transmission and processing latencies, resulting in better performance for live analysis. Moreover, encryption can also be used to add another layer of security and authenticity to the data stream. FIGS. 6-24 illustrate an example packet structure that can be used efficiently over multiple transports. Variations on this example packet structure are possible, while still maintaining the packet structure characteristics described.

Communications can be restricted such that no client detection tool can communicate with more than one server detection agent, and vice versa, and such that the client detection tool initiates the communication process. For example, the client can broadcast a message over a network, and any server agent running on the network can respond to this message acknowledging its presence. The client can select a server agent with whom to establish a connection and send a request for communication to the selected server agent, and the client can identify itself in the request using a Globally Unique Identifier (GUID). The server agent can accept the connection upon receipt of the request, and the server agent can acknowledge the client with its own identifier (another GUID). For the rest of the session, both the client and the server can exchange their identities with every request and response. Once a communication is established between a client and a server, the server can be restricted to not respond to any other requests or broadcasts from other clients. Finally, the client can be the party required to close the session and release the server. If for any reason the communication has broken down without proper closing of the session, the server can be required to be released manually by the user.

FIG. 6 illustrates a header structure for the packets, showing the offset, size in bytes and data type of each field (UINT is an unsigned integer, UUID is a Universal Unique Identifier, BOOL is a Boolean, and CHAR is a character). A first field 600 specifies the size of the packet. A second field 610 specifies the GUID to be quoted for the communication, which can be filled with F's or 0's for the messages used before the connection is setup. A third field 620 specifies the GUID of the packet, which can be used to identify the packet. A fourth field 630 specifies whether encryption is being used (e.g., no encryption or TwoFish encryption). The fourth field 630 can alternatively be a larger field used to specify a particular type of encryption to be used (e.g., multiple encryption schemes can be made available). A fifth field 640 specifies an IP Address of the client/server sending the packet (e.g., used for checking purpose). For parallel port communication, this field can be set to 000.000.000.000. A sixth field 650 can hold a command block or a response block.

The client can query for information from the server by sending a request, and in response to the client request, the server can fill the respective structure and send it back to the client. FIG. 7 illustrates a command block structure (the offsets are relative to the start of the structure in the main packet). The command block is sent by the client to the server to request some data. A first field 700 specifies a command identifier. A second field 710 specifies the command parameters, which depend on the command identifier. FIG. 8 illustrates a response block structure. The server sends the response block to the client with the requested data as a response to the command from the client. A first field 800 specifies the request identifier. A second field 810 provides the requested data, where the size and structure depends on the request identifier.

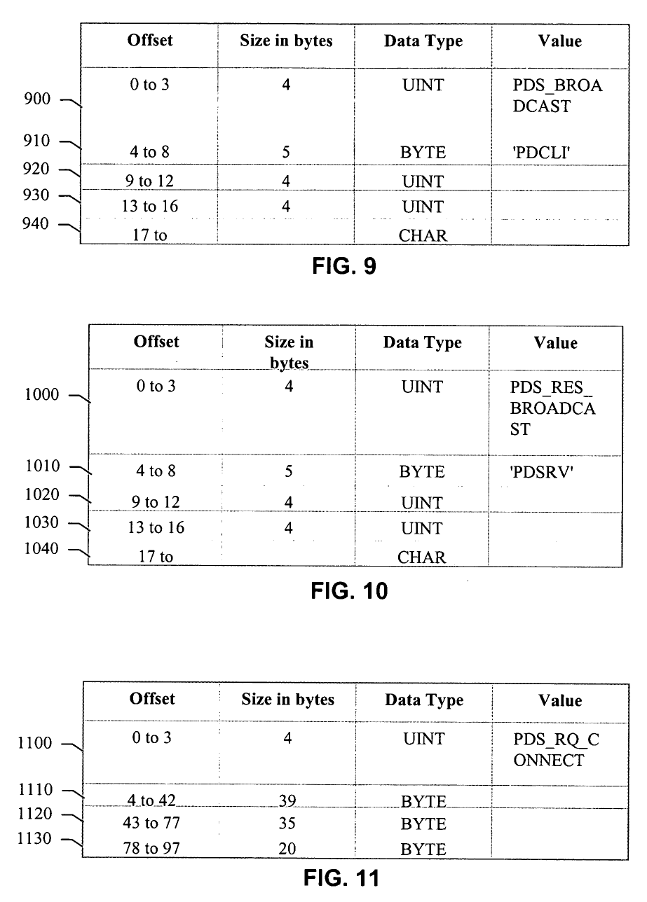

FIG. 9 illustrates the client's broadcast message structure. A first field 900 specifies the broadcast message from the server. A second field 910 specifies the client signature. A third field 920 specifies the version of the client. A fourth field 930 specifies the size of the client name. A fifth field 940 specifies the client name.

FIG. 10 illustrates packet structure of the server response to the client's broadcast message. A first field 1000 specifies the connection establishment request from the server. A second field 1010 specifies the server signature. A third field 1020 specifies the version of the server. A fourth field 1030 specifies the size of the server name. A fifth field 1040 specifies the server name.

The client sends a request to the server for establishment of a connection with that server. As a part of the request, the client generates a GUID on fly and sends it to the server. Once the server accepts the connection request, this GUID should be quoted in all the responses from the server. FIG. 11 illustrates the request for establishment of a connection. A first field 1100 specifies a request to establish a connection. A second field 1110 specifies the GUID of the server (this GUID is used for further communication). A third field 1120 specifies the name of the machine sending the request. A fourth field 1130 specifies a password to connect to the server (NULL if the server is not using any password to connect).

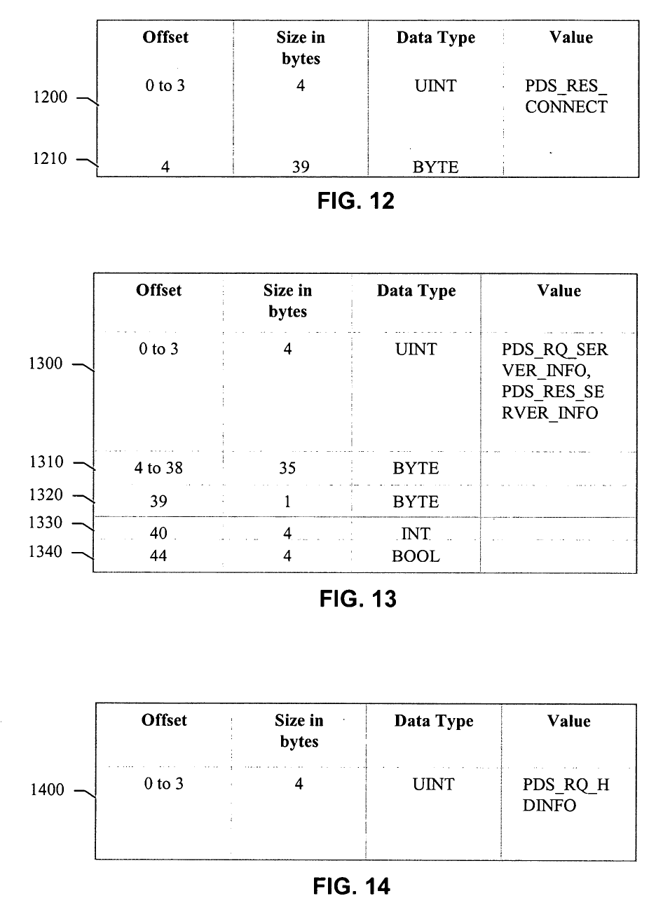

FIG. 12 illustrates the server response for establishment of the connection. The server confirms the connection accepting the connection establishment, and the server also generates a GUID on fly and sends it to the client. The client then quotes that GUID in all its requests. A first field 1200 specifies the response to the request for connection establishment. A second field 1210 specifies, when the connection can be established, the GUID from the server to be quoted in further communication (the server should not respond to the client if the connection can not be established).

FIG. 13 illustrates the client's request for sending the server information. This round of communication can be used to determine whether the server is password protected. The server and client can use the same packet structure for request and response, and this packet can be encrypted using TwoFish encryption with a default seed string of the client and server. A first field 1300 specifies the request/response to get/inform the server information. A second field 1310 specifies the name of the machine sending the packet. A third field 1320 specifies whether the server is protected. A fourth field 1330 specifies time zone information (e.g., the index of the time zone on which the current machine is running). A fifth field 1340 specifies whether a daylight setting is on.

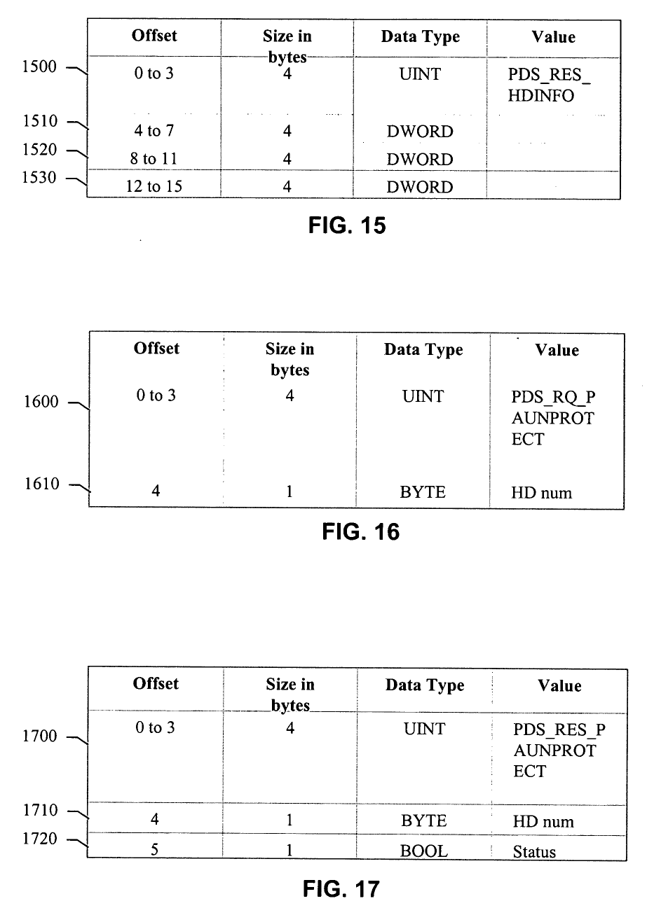

FIG. 14 illustrates a request for information regarding connected hard disks. A field 1400 specifies the request to send the hard disks' information. FIG. 15 illustrates the server response regarding connected hard disks. A first field 1500 specifies the response to the hard disk information request. A second field 1510 specifies the number of hard disks connected to the remote machine. A third field 1520 specifies the number of sectors available on hard disk zero. A fourth field 1530 specifies where the protected area starts (−1 to indicate no protected area). If the remote system has more than one hard disk, the information in bytes 8 to 15 can be repeated thereafter for each hard disk.

FIG. 16 illustrates a request to unprotect the protected area. A first field 1600 specifies the request to unprotect the protected area. A second field 1610 specifies the hard disk number to be unprotected. FIG. 17 illustrates a response to the request to unprotect the protected area. A first field 1700 specifies the response for the request to unprotect the protected area. A second field 1710 specifies the requested hard disk number. A third field 1720 specifies whether the protected area was successfully unprotected.

FIG. 18 illustrates a request for read sector(s) sent from the client to the server. A first field 1800 specifies the request to read sector(s). A second field 1810 specifies the hard disk number from where the sector(s) should be read. A third field 1820 specifies the starting sector number. A fourth field 1830 specifies the number of bytes to read.

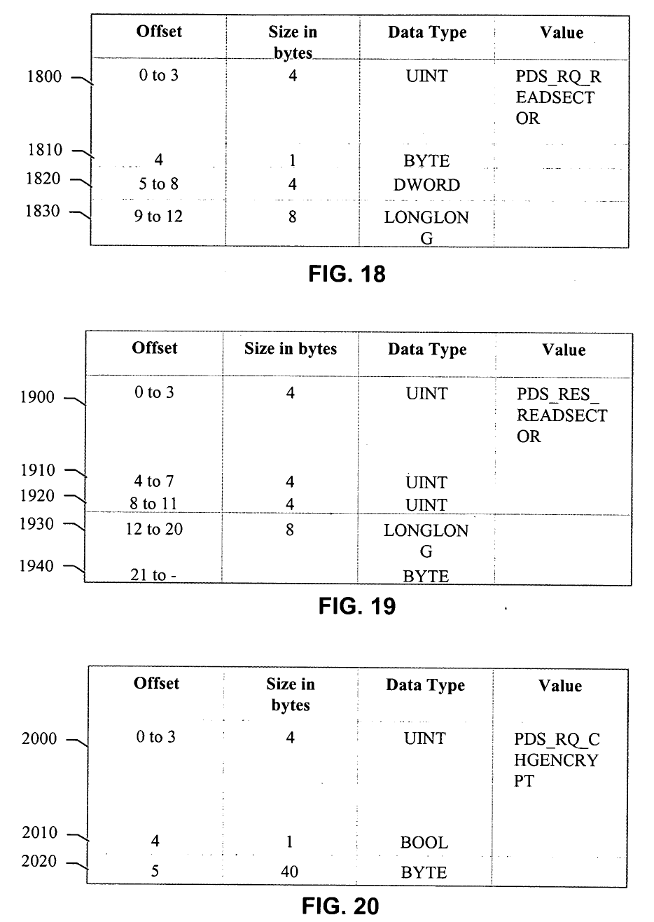

FIG. 19 illustrates a response to the read sector(s) request. While sending this to the client, the server can split the data into more than one packet according to its convenience. In such a case, the number of packets and the current packet number fields of the illustrated structure are filled. A first field 1900 specifies the response to read sector(s). A second field 1910 specifies the current packet number. A third field 1920 specifies the total number of packets. A fourth field 1930 specifies the number of bytes read from the hard disk. A fifth field 1940 specifies the information read from the hard disk.

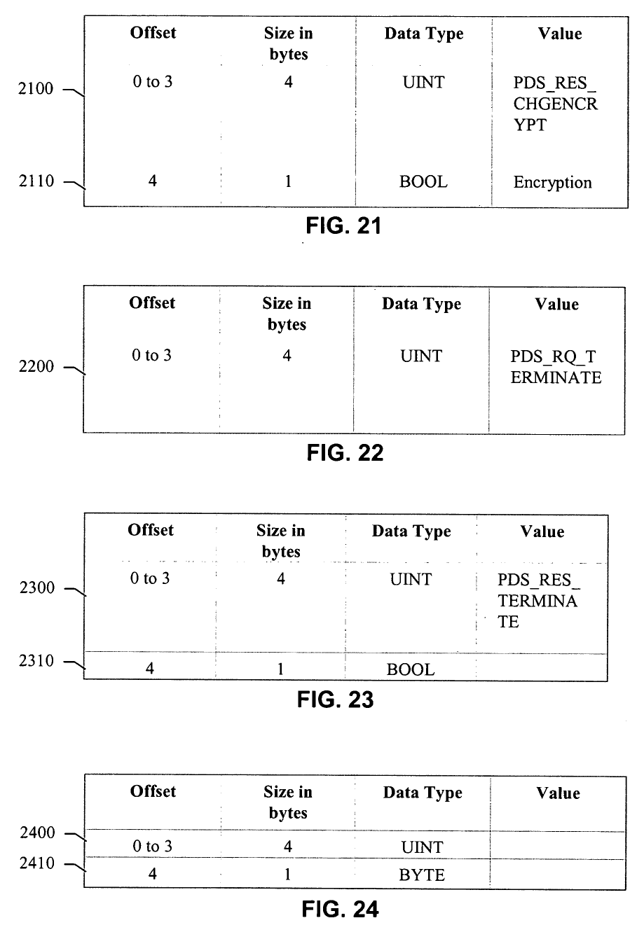

FIG. 20 illustrates a client request to change the encryption setting. A first field 2000 specifies the request to change the encryption setting. A second field 2010 specifies whether encryption has been used. A third field 2020 specifies a seed key for the encryption. FIG. 21 illustrates a response for changing the encryption setting. A first field 2100 specifies the response for the request to change the encryption setting. A second field 2110 specifies whether the encryption setting has been successfully changed.

FIG. 22 illustrates a request for terminating the connection, which can be sent by either client or server. A field 2200 specifies the request to terminate the connection. FIG. 23 illustrates a response for terminating the connection. A first field 2300 specifies the response for the request to terminate the connection. A second field 2310 specifies whether the connection has been terminated or cannot be terminated. Additionally, two parameters can be placed outside of the normal packet. Accordingly, FIG. 24 illustrates an initial portion of the packet structure. A first field 2400 specifies the size of the packet. A second field 2410 specifies whether the remainder of the packet is encrypted. The remainder of the packet starts at byte 5. Thus, the first five bytes of an incoming packet can be read to determine the size and encryption state of the incoming packet.

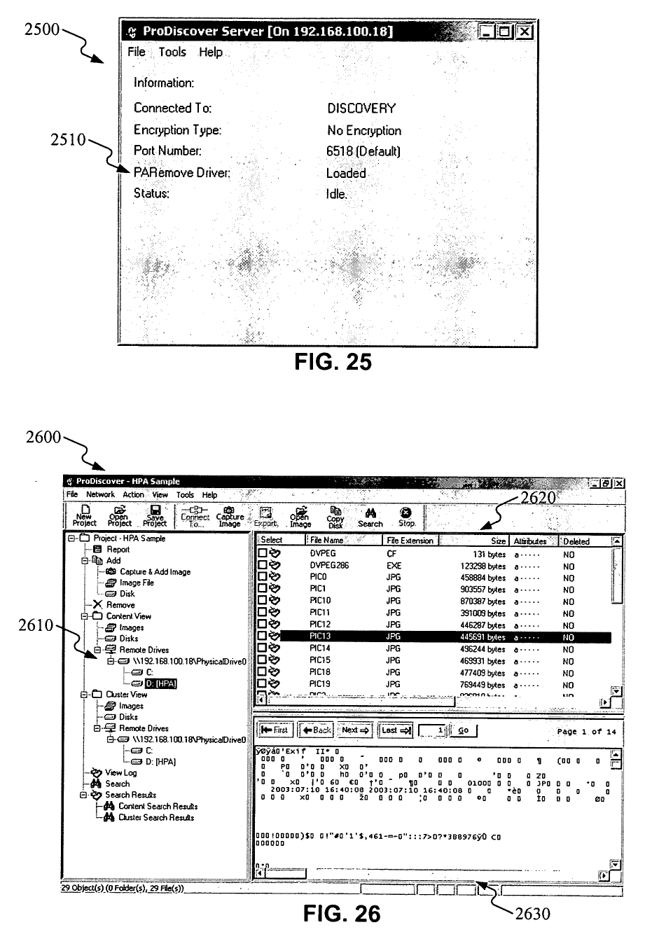

The detection tool described above can be a software application designed for use in computer forensics, security, internal investigations, incident response, electronic discovery and/or intrusion detection. FIGS. 25-26 illustrate user interfaces for an example client-server computer forensics product. The computer forensics product, called “ProDiscover-Investigator” is being used to remotely analyze a disk containing a Hardware Protected Area. A program window 2500 for a server remote agent is shown. The server remote agent in this example is running on a suspect machine containing a HPA with graphic files placed inside the HPA. An information item “PARemove Driver” 2510 indicates that the driver has been loaded by the remote agent. Once the remote agent is running on the suspect machine, the client forensics tool (i.e., the ProDiscover console application acting as the client) can connect to the remote agent and access any disk on the machine running the remote agent as though it was local, including accessing any HPA.

In FIG. 26, a program window 2600 for the client forensics tool is shown. A left-side sub-window contains a tree-view that shows the remote disk as having been added to the project as item 2610: “\\192.168.100.18\PhysicalDrive0”. Below this, both the normally viewable disk partition “C:”, and the second partition “D:[HPA]” are shown. The driver running on the suspect machine has allowed the ProDiscover client application to also access the HPA as illustrated. A work area 2620 shows files contained within the HPA, including a specific graphic file that has been highlighted. When a file is highlighted, a data view area 2630 shows the raw file contents. Thus, a user of the forensics tool can examine files within the HPA just as they would any normal disk partition, and this can be done remotely over a network on a live system without altering the evidence or rebooting either the local or remote systems.

The logic flows depicted do not require the particular order shown, or sequential order, to achieve desirable results. Although only a few embodiments have been described in detail above, other modifications are possible. Other embodiments may be within the scope of the following claims.

What is claimed is:

1. An article comprising a machine-readable medium embodying information indicative of instructions that when performed by one or more machines result in operations comprising:
determining whether a storage device, in a data processing system running an operating system, includes a protected area, the operating system including a hardware abstraction layer;
removing the storage area protection of the storage device from within the running operating system and without rebooting the data processing system; and
providing information derived from the formerly protected storage area to a data processing system detection tool.

2. The article of claim 1, wherein the operating system further includes a graphical user interface (GUI), virtual memory management and multitasking.

3. The article of claim 1, wherein determining whether the storage device includes the protected area comprises:
checking whether the storage device supports a protected area specification; and
identifying a protected storage capacity and an unprotected storage capacity of the storage device.

4. The article of claim 1, wherein removing the storage area protection comprises volatilely resetting a storage address value.

5. The article of claim 4, wherein resetting a storage address value comprises calling a MAX ADDRESS command.

6. The article of claim 4, wherein said determining and said removing occur in a kernel-mode of the data processing system.

7. The article of claim 4, wherein the storage area protection of the storage device is restored by the data processing system upon system reboot, leaving the storage device unaltered.

8. The article of claim 1, wherein the operations further comprise:
scanning the formerly protected storage area; and
identifying file system information in the formerly protected storage area.

9. The article of claim 1, wherein providing the information derived from the formerly protected storage area comprises sending the information over a transport medium to the data processing system detection tool.

10. The article of claim 9, wherein the operations further comprise reconstructing a file system of the formerly protected storage area to derive the information.

11. The article of claim 9, wherein providing the information derived from the formerly protected storage area further comprises selecting the transport medium from a group including a peripheral device interface medium and a network communications medium.

12. The article of claim 11, wherein sending the information over the transport medium comprises sending the information in packets having a packet structure useable over both the peripheral device interface medium and the network communications medium.

13. The article of claim 12, wherein the packet structure is useable over a Universal Serial Bus (USB) and over an Internet Protocol (IP) network.

14. The article of claim 12, wherein the packet structure includes a packet identifier field, and the operations further comprise specifying a detection-tool packet identifier for each packet.

15. The article of claim 12, wherein the packet structure allows for only a one-to-one connection.

16. The article of claim 12, wherein the packet structure specifies small packets to reduce latency.

17. A method comprising:
loading a kernel-mode software module in a computing system running an operating system; and
without rebooting the computing system, using the kernel-mode software module to perform operations from within the operating system, the operations comprising
determining whether a storage device in the computing system includes a protected area, and
reversibly removing the storage area protection.

18. The method of claim 17, wherein loading the kernel-mode software module comprises communicatively coupling a machine-readable medium with the computing system, a detection agent being tangibly embodied in the machine-readable medium to run and dynamically load the kernel-mode software module without altering the storage device.

19. The method of claim 18, wherein the machine-readable medium comprises an optical disk.

20. The method of claim 17, further comprising:
scanning the formerly protected storage area; and
identifying file system information in the formerly protected storage area.

21. The method of claim 17, further comprising sending information derived from the formerly protected storage area over a selected transport medium to a data processing system detection tool.

22. The method of claim 21, wherein sending the information over the selected transport medium comprises sending the information in packets having a packet structure useable over both a peripheral device interface medium and a network communications medium.

23. The method of claim 22, wherein the packet structure includes a packet identifier field used by the detection tool, and the packet structure specifies small packets to reduce latency.

24. A system comprising:
a data processing system detection tool; and
a kernel-mode software module operable to provide the detection tool with access to a protected area of a storage device in a data processing system when the kernel-mode software module is loaded into the data processing system.

25. The system of claim 24, wherein the detection tool is operable from within the data processing system to access the storage device over a bus, the system further comprising a hardware write blocker operable to allow the kernel-mode software module access to a firmware command.

26. The system of claim 24, wherein the detection tool is operable as a stand alone application and as a client application.

27. The system of claim 24, further comprising a detection agent operable to send information to the detection tool, the detection agent being operable to load the kernel-mode software module in the data processing system and communicate with the loaded kernel-mode software module and with the detection tool.

28. The system of claim 27, wherein the detection agent is further operable to reconstruct a file system of the protected storage area and send the reconstructed file system information to the detection tool.

29. The system of claim 27, wherein the detection agent is further operable to select a transport medium from a group including a peripheral device interface medium and a network communications medium, and the detection agent communicates with the detection tool using a common a packet structure useable over both the peripheral device interface medium and the network communications medium.

30. The system of claim 29, wherein the packet structure includes a packet identifier field used by the detection tool, and the packet structure specifies small packets to reduce latency.

31. The system of claim 24, further comprising a software write blocker.

32. The system of claim 24, wherein the detection tool comprises a computer forensics tool.

33. The system of claim 24, wherein the kernel-mode software module comprises a device driver.

34. The system of claim 33, wherein the device driver comprises a Windows Driver Model (WDM) driver.

35. The system of claim 33, wherein the storage device comprises an ATA hard disk.

36. A system comprising:
means for directly accessing a protected area of a storage device in a data processing system live from a high level operating system without a reboot; and
means for delivering information derived from the protected storage area to a data processing system detection tool.

37. The system of claim 36, wherein the means for delivering comprises multi-transport means for delivering the information, including means for communicating over a network to support remote imaging and analysis of the directly accessed protected area.
